(19) United States
(12) Patent Application Publication
(10) Pub. No.: US 2016/0247322 A1
(43) Pub. Date: Aug. 25, 2016

(54) ELECTRONIC APPARATUS, METHOD AND STORAGE MEDIUM

(71) Applicant: KABUSHIKI KAISHA TOSHIBA, Tokyo (JP)

(72) Inventor: Hiroaki KOMAKI, Tachikawa Tokyo (JP)

(21) Appl. No.: 14/877,206

(22) Filed: Oct. 7, 2015

Related U.S. Application Data
(60) Provisional application No. 62/119,684, filed on Feb. 23, 2015.

(51) Int. Cl. G06T 19/00; G02B 27/01; G06F 3/01

(52) U.S. Cl. CPC G06T 19/006; G06F 3/013; G02B 27/0172; G02B 27/0179; G02B 2027/0178; G02B 2027/0138; G02B 2027/0187

(57) ABSTRACT

According to one embodiments, a method is executed by an electronic apparatus with a first display area and a second display area. The method includes displaying, in the first display area, a first image associated with a first object which exists in a field of view of a user; displaying, in the second display area, a second image associated with the first object; and determining a first distance from the electronic apparatus to an intersection point based on a display position of the first image and a display position of the second image, the intersection point between sight-lines of the user's left and right eyes through the first and second images. The display positions are determined based on a second distance from the electronic apparatus to the first object.

### CROSS-REFERENCE TO RELATED APPLICATIONS

This application claims the benefit of U.S. Provisional Application No. 62/119,684, filed Feb. 23, 2015, the entire contents of which are incorporated herein by reference.

### FIELD

Embodiments described herein relate generally to an electronic apparatus, a method and a storage medium.

### BACKGROUND

Recently, electronic apparatuses that the user can wear and use have been developed. Such electronic apparatuses are called wearable devices.

The wearable devices are designed in various forms. For example, an eyeglass wearable device is known as a device wearable on the user's head.

In the eyeglass wearable device, for example, various types of information can be displayed on a display having a transmitting property and provided at the position of lenses in the form of eyeglasses. The information displayed on the display includes, for example, an image.

When an image is displayed on each of a display area for the left eye and a display area for the right eye of the display provided in the eyeglass wearable device, the user can see a virtual image (hereinafter referred to as an augmented reality [AR] image) behind the display.

That is, when the user wears the eyeglass wearable device, the user can see both a target (object) which exists in reality and the AR image through the display.

When the user switches his eyes between the target which exists in reality and the AR image, however, the focus and convergence of the eyes must be accommodated, which places a burden on the eyes of the user wearing the eyeglass wearable device.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective illustration showing an example of an appearance of an electronic apparatus according to an embodiment.

FIG. 2 is a diagram showing an example of a system configuration of the electronic apparatus.

FIG. 3 is a block diagram showing an example of a function structure of the electronic apparatus.

FIG. 4 is an illustration of an example of an adjustment of a convergence distance.

FIG. 5 is an illustration of an example of the adjustment of the convergence distance.

FIG. 6 is an illustration of an example of the adjustment of the convergence distance.

FIG. 7 is a flowchart showing an example of a procedure for calibration processing.

FIG. 8 is a flowchart showing an example of a procedure for image display processing.

### DETAILED DESCRIPTION

Various embodiments will be described hereinafter with reference to the accompanying drawings.

In general, according to one embodiment, a method is executed by an electronic apparatus worn by a user with a transparent first display area and a transparent second display area. The method includes: displaying, in the first display area, a first image associated with a first object which exists in a field of view of a user; displaying, in the second display area, a second image associated with the first object; and determining a first distance from the electronic apparatus to an intersection point based on a display position of the first image and a display position of the second image, the intersection point between a sight-line from the user's left eye through the first image and a sight-line from the user's right eye through the second image. The display positions of the first image and the second image are determined based on a second distance from the electronic apparatus to the first object.

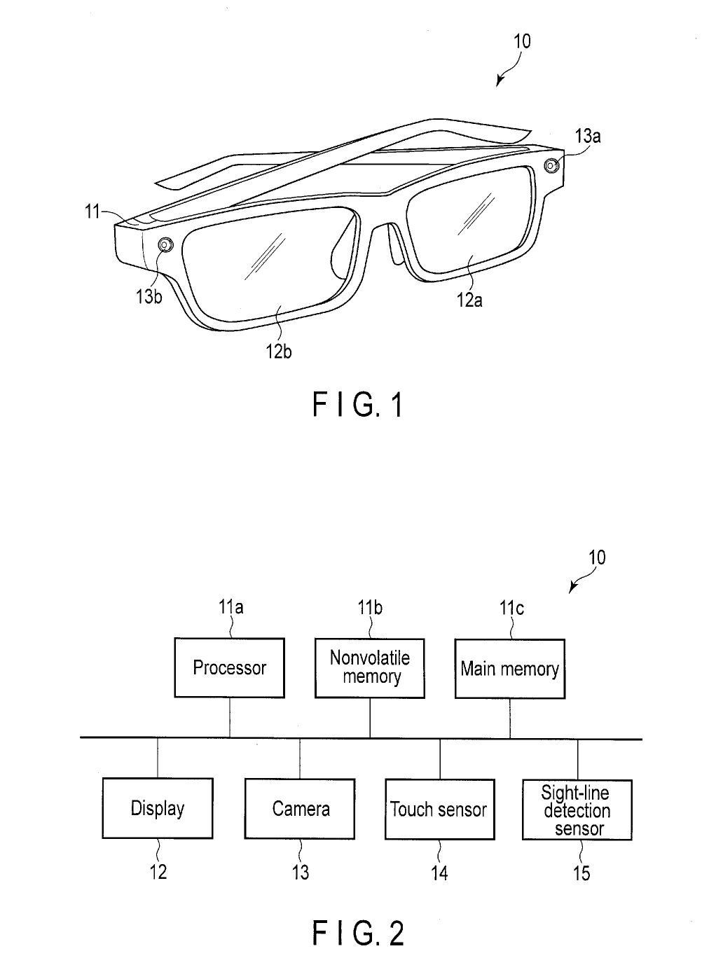

FIG. 1 is a perspective illustration showing an example of an appearance of an electronic apparatus according to an embodiment. The electronic apparatus is, for example, a wearable device (head-mounted display device) worn on the user's head and used. FIG. 1 shows an example of implementing the electronic apparatus as a wearable device in the form of eyeglasses (hereinafter referred to as an eyeglass wearable device). In the description below, the electronic apparatus of the present embodiment is assumed to be implemented as an eyeglass wearable device.

An electronic apparatus 10 shown in FIG. 1 includes an electronic apparatus body 11. The electronic apparatus body 11 is incorporated in, for example, a frame portion of the electronic apparatus 10 in the form of eyeglasses (hereinafter referred to as a frame portion of the electronic apparatus 10). The electronic apparatus body 11 may be attached to, for example, the side surface of the frame portion of the electronic apparatus 10.

The electronic apparatus 10 further includes a display. The display is supported at the position of lenses of the electronic apparatus 10 in the form of eyeglasses. More specifically, the display has a transmitting property and includes a display (hereinafter referred to as a left-eye display) 12a serving as a display area (first display area) for the left eye of the user and a display (hereinafter referred to as a right-eye display) 12b serving as a display area (second display area) for the right eye of the user.

When such an electronic apparatus 10 is mounted on the user's head, at least a part of the user's field of view is secured in a direction of the displays 12a and 12b. In other words, the user can see an object which exists in reality while wearing the electronic apparatus 10.

In the electronic apparatus 10 shown in FIG. 1, the left-eye display 12a and the right-eye display 12b are independently provided. However, the display area for the left eye and the display area for the right eye may be provided on a single display.

The electronic apparatus 10 further includes a camera. The camera of the present embodiment is configured as a stereo camera. The camera includes a left-eye camera 13a and a right-eye camera 13b. The left-eye camera 13a is mounted near the left-eye display 12a in the frame portion of the electronic apparatus 10. The right-eye camera 13b is mounted near the right-eye display 12b in the frame portion of the electronic apparatus 10. The left-eye camera 13a and the right-eye camera 13b are provided in the orientation in which an image of a scene in the direction of the user's field of view can be captured when the user is wearing the electronic apparatus 10. The left-eye camera 13a and the right-eye camera 13b may be provided at positions other than the positions shown in FIG. 1 as long as the left-eye camera 13a and the right-eye camera 13b are provided near the left eye and the right eye of the user, respectively.

A touch sensor, a sight-line detection sensor and the like to be described layer (not shown in FIG. 1) are further provided in the frame portion of the electronic apparatus 10.

FIG. 2 is a diagram showing an example of a system configuration of the electronic apparatus 10. As shown in FIG. 2, the electronic apparatus 10 includes, for example, a processor 11a, a nonvolatile memory 11b, a main memory 11c, a display 12, a camera 13, a touch sensor 14 and a sight-line detection sensor 15. In the present embodiment, the processor 11a, the nonvolatile memory 11b and the main memory 11c are provided in the electronic apparatus body 11.

The processor 11a is a processor that controls operation of each component in the electronic apparatus 10. The processor 11a executes various types of software loaded from the nonvolatile memory 11b serving as a storage device to the main memory 11c. The processor 11a includes at least one processing circuitry such as a CPU or an MPU.

The display 12 is a display device to display various types of information (display data). The display 12 includes the left-eye display 12a and the right-eye display 12b shown in FIG. 1. For example, information displayed on the display 12 may be stored in the electronic apparatus 10 or may be acquired from an external apparatus. When the information displayed on the display 12 is acquired from an external apparatus, for example, wireless or wired communication is performed between the electronic apparatus 10 and the external apparatus via a communication device (not shown). The electronic apparatus 10 can also transmit information other than the information displayed on the display 12 to the external apparatus and receive such information from the external apparatus via the communication device.

The information displayed on the display 12 includes, for example, an image related to an object which exists in reality and is seen through the display 12. In the description below, the information displayed on the display 12 is assumed to be an image.

The camera 13 is an imaging device capable of capturing an image of the periphery of the electronic apparatus 10. The camera 13 includes the left-eye camera 13a and the right-eye camera 13b shown in FIG. 1. The camera 13 can capture an image of a scene including various objects which exist in (the direction of) the user's field of view. For example, the camera 13 can capture still images and moving images.

The touch sensor 14 is, for example, a sensor configured to detect a contact position of the user's finger. For example, the touch sensor 14 is provided in the frame portion of the electronic apparatus 10. More specifically, the touch sensor 14 is provided in a portion (hereinafter referred to as a temple portion) of the frame portion of the electronic apparatus 10 which is other than a portion (hereinafter referred to as a front portion) supporting the display 12 and includes an earpiece. The touch sensor 14 may be provided in either or both of temple portions positioned on the right side and the left side of the user, respectively, when the user is wearing the electronic apparatus 10. The touch sensor 14 may be provided in a portion other than the temple portions, for example, in the front portion. As the touch sensor 14, for example, a touchpanel can be used.

The sight-line detection sensor (sight-line detector) 15 is, for example, a sensor configured to detect a sight-line of the user. For example, a camera capable of capturing an image of the movement of the user's eye can be used as the sight-line detection sensor 15. In this case, the sight-line detection sensor 15 is mounted at a position where an image of the movement of the user's eye can be captured, for example, on the inside of the frame portion (front portion) of the electronic apparatus 10. A Camera that can be used as the sight-line detection sensor 15 includes, for example, an infrared camera having a function of capturing an image of infrared light and a visible light camera having a function of capturing an image of visible light.

The configuration may be made such that the display 12, the camera 13, the touch sensor 14 and the sight-line detection sensor 15 shown in FIG. 2 are provided in the electronic apparatus 10 and the processor 11a, the nonvolatile memory 11b, the main memory 11c, the communication device and the like are provided in a housing (external device) other than the electronic apparatus 10. In this case, the weight of the electronic apparatus 10 (eyeglass wearable device) can be reduced by connecting the electronic apparatus 10 to the external device wirelessly or by cable.

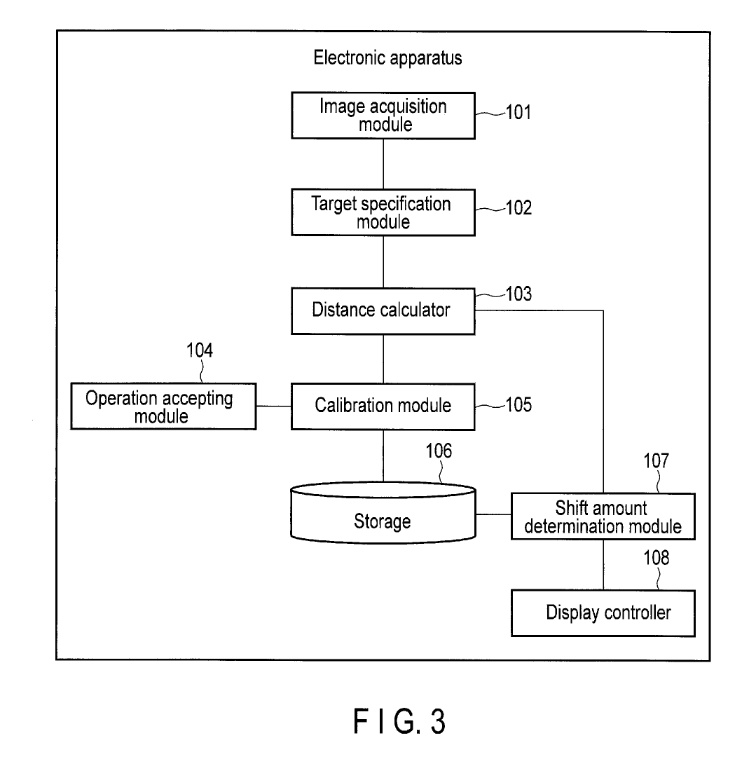

FIG. 3 is a block diagram mainly showing a function structure of the electronic apparatus 10. The electronic apparatus 10 of the present embodiment has a function of displaying images on the display 12 such that a virtual image (hereinafter referred to as an AR image) is formed on a target (object) which exists in reality and is seen through the display 12.

As shown in FIG. 3, the electronic apparatus 10 includes an image acquisition module 101, a target specification module 102, a distance calculator 103, an operation accepting module 104, a calibration module 105, a storage 106, a shift amount determination module 107 and a display controller 108.

All or a part of the image acquisition module 101, the target specification module 102, the distance calculator 103, the operation accepting module 104, the calibration module 105, the shift amount determination module 107 and the display controller 108 may be implemented by causing the processor 11a to execute a program, i.e., implemented by software, implemented by hardware such as an integrated circuit (IC) or implemented as a combinational structure of software and hardware.

In the present embodiment, the storage 106 is stored in the nonvolatile memory 11b. The storage 106 may be included in an external apparatus communicably connected to the electronic apparatus 10.

The image acquisition module 101 acquires images (for example, still images) of a scene in the direction of the user's sight-line captured by the camera 13 (the left-eye camera 13a and the right-eye camera 13b). The images acquired by the image acquisition module 101 include various objects which exist in the direction of the user's sight-line.

The target specification module 102 specifies an object that the user is fixating on (i.e., an object that exists ahead of the user's sight-line) from the objects included in the images acquired by the image acquisition module 101 as a target, based on the user's sight-line (direction) detected by the sight-line detection sensor 15.

For example, the distance calculator 103 calculates a distance from (the user wearing) the electronic apparatus 10 to the target specified by the target specification module 102 based on the images acquired by the image acquisition module 101 (i.e., the images captured by the left-eye camera 13a and the right-eye camera 13b).

The operation accepting module 104 has a function of accepting an operation of the electronic apparatus 10 performed by the user. Operations accepted by the operation accepting module 104 include, for example, an operation of the touch sensor 14.

The calibration module 105 displays an image (hereinafter referred to as a calibration image) of a predetermined mark for calibration (for example, a cross) at a predetermined position on each of the left-eye display 12a and the right-eye display 12b. The user can thereby see an AR image of the predetermined mark behind the display 12.

When the display positions of the calibration images on the display 12 are shifted to the left or the right, a convergence distance (convergence angle) of the user is changed and the position (perspective) of the AR image of the predetermined mark seen by the user is also changed. In the present embodiment, the user can shift the display positions of the calibration images on the display 12 to the left or the right by performing a predetermined operation of the electronic apparatus 10. More specifically, the user shifts the display positions of the calibration images on the display 12 such that the AR image of the predetermined mark is formed (seen) at a position corresponding to a target which exists in reality and is seen through the display 12.

The calibration module 105 generates calibration data based on the distance calculated by the distance calculator 103 and an amount of the shift (hereinafter referred to as a shift amount) of the calibration images made in response to the user operation (i.e., the operation accepted by the operation accepting module 104). The calibration data is stored in the storage 106.

The shift amount determination module 107 determines a shift amount to be applied to images (hereinafter referred to as display images) displayed on the display 12 based on the distance calculated by the distance calculator 103 and the calibration data stored in the storage 106.

The display controller 108 shifts display positions of the display images on the display 12 based on the shift amount determined by the shift amount determination module 107.

The operation of the electronic apparatus 10 of the present embodiment is hereinafter described. When a person fixates on an object, the focus and convergence of his eyes are generally accommodated. In an eyeglass wearable device that allows the user to see both a target which exists in reality and the above-described AR image, a case where the user switches his eyes between the target and the AR image is assumed. In this case, when an accommodation distance (focal distance) of the crystalline lenses and a convergence distance in the case of fixating on the target are greatly different from an accommodation distance of the crystalline lenses and a convergence distance in the case of fixating on the AR image, the switching of the user's eyes between the target and the AR image places a significant burden on the eyes. This may cause eyestrain and a headache.

Therefore, the electronic apparatus 10 of the present embodiment has a function of adjusting the convergence distance in the case of fixating on the AR image depending on a distance to a target fixated on through the display 12.

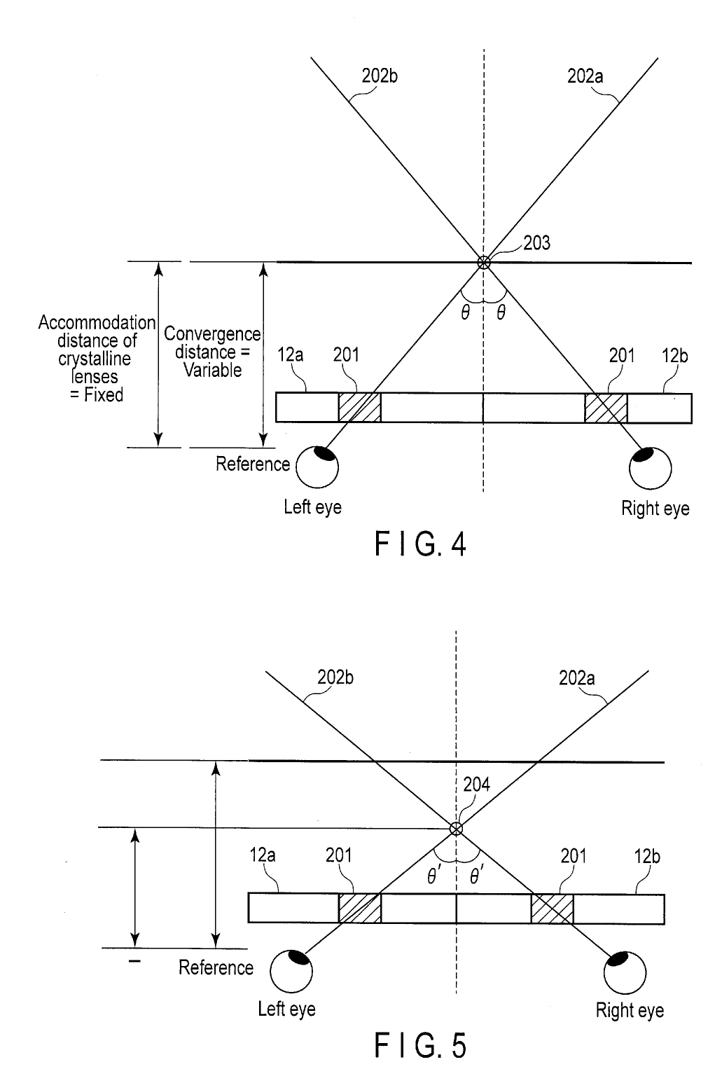

First, a brief description of the adjustment of the convergence distance in the present embodiment is provided with reference to FIG. 4 to FIG. 6.

As shown in FIG. 4, display images 201 are displayed on the display 12 (the left-eye display 12a and the right-eye display 12b) such that an AR image is seen at an accommodation distance of the crystalline lenses preset in an optical system (i.e., seen in a constant focus). In the present embodiment, a convergence distance is adjusted (changed) with reference to a convergence distance in the case of fixating on the AR image seen in the above case. In the description below, positions on the left-eye display 12a and the right-eye display 12b at which the display images are displayed in this state are called reference positions.

In the present embodiment, the convergence distance is defined as a distance (first distance) from the electronic apparatus 10 (or a surface including the two pupils of the user) to an intersection point 203 of the user's sight-line 202a passing from the pupil of the left eye of the user through the display image 201 displayed on the left-eye display 12a and the user's sight-line 202b passing from the pupil of the right eye of the user through the display image 201 displayed on the right-eye display 12b. An angle formed by a line perpendicular to the surface including the two pupils of the user and the sight-line of each of the user's eyes (left and right eyes) is referred to as a convergence angle. The convergence angle in FIG. 4 is θ.

It is assumed that the display position of the display image 201 on the left-eye display 12a is shifted from the reference position to the right side and the display position of the display image 201 on the right-eye display 12b is shifted from the reference position to the left side, the displays being provided in front of the user's eyes by the user wearing the electronic apparatus 10, as shown in FIG. 5. A convergence angle θ′ in this case is greater than the convergence angle θ in FIG. 4 and a distance from the electronic apparatus 10 to an intersection point 204 of the user's sight-lines 202a and 202b (i.e., convergence distance) is shorter than the reference convergence distance described above. That is, when an interval between the display position of the display image 201 on the left-eye display 12a and the display position of the display image 201 on the right-eye display 12b is reduced, the convergence distance can also be reduced. The AR image in this case is an image in the protruding direction in binocular stereopsis.

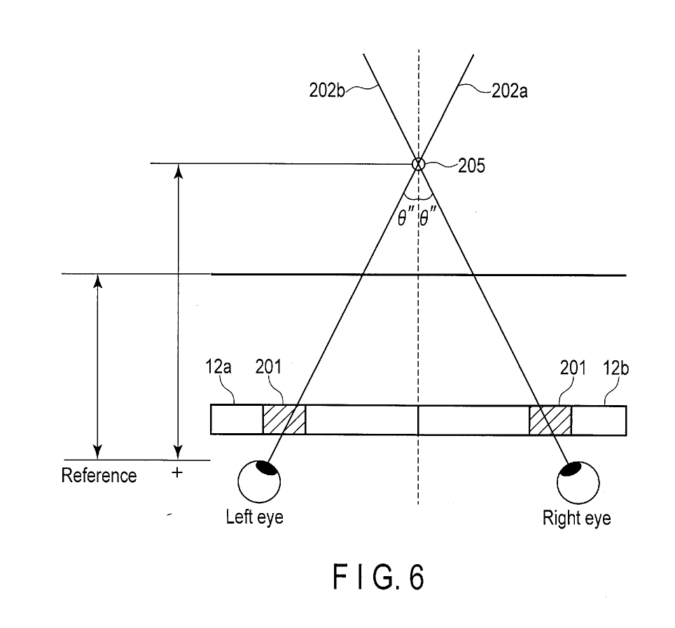

In contrast, it is assumed that the display position of the display image 201 on the left-eye display 12a is shifted from the reference position to the left side and the display position of the display image 201 on the right-eye display 12b is shifted from the reference position to the right side, the displays being provided in front of the user's eyes by the user wearing the electronic apparatus 10, as shown in FIG. 6. A convergence angle θ″ in this case is less than the convergence angle θ in FIG. 4 and a distance from the electronic apparatus 10 to an intersection point 205 of the user's sight-lines 202a and 202b (i.e., convergence distance) is longer than the reference convergence distance described above. That is, when the interval between the display position of the display image 201 on the left-eye display 12a and the display position of the display image 201 on the right-eye display 12b is increased, the convergence distance can also be increased. The AR image in this case is an image in the recessed direction in binocular stereopsis.

That is, the above-described convergence distance is determined depending on the display position of the display image 201 on the left-eye display 12a and the display position of the display image 201 on the right-eye display 12b. In the present embodiment, the display position of the display image 201 on the left-eye display 12a and the display position of the display image 201 on the right-eye display 12b are determined in accordance with a distance (second distance) from the electronic apparatus 10 to the target which exists in reality and is seen through the display 12.

The electronic apparatus 10 of the present embodiment executes processing (hereinafter referred to as calibration processing) of generating the above-described calibration data and processing (hereinafter referred to as image display processing) of displaying the display images to adjust the above-described convergence distance, which will be hereinafter described.

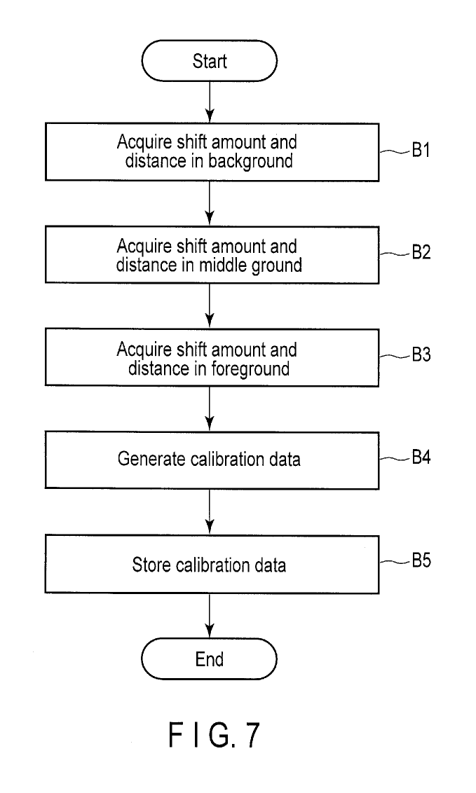

A procedure of the calibration processing is hereinafter described with reference to a flowchart of FIG. 7. Since pupillary distance generally varies according to age and sex, calibration conforming to the user's pupillary distance is necessary to set a convergence distance (convergence angle) depending on the distance to the target that the user is fixating on. In the present embodiment, therefore, the calibration processing is executed as preprocessing of the image display processing to be described later.

First, the display controller 108 displays calibration images on the left-eye display 12a and the right-eye display 12b, respectively, such that an AR image of a predetermined mark is seen, for example, near the center of the user's field of view. The calibration images in this case are displayed at the reference positions on the left-eye display 12a and the right-eye display 12b, respectively, such that the AR image is seen at the predetermined accommodation distance of the crystalline lenses and the reference convergence distance described above.

Next, the user accommodates the convergence distance in the case of fixating on the AR image of the predetermined mark by, for example, performing an operation of the touch sensor 14 provided in the temple portion of the electronic apparatus 10. More specifically, while fixating on an arbitrary target seen in the background from the user, the user makes an accommodation by horizontally shifting the display positions of the calibration images on the left-eye display 12a and the right-eye display 12b such that the convergence distance in the case of fixating on the target corresponds to the convergence distance in the case of fixating on the AR image (i.e., such that the user feels that the AR image is at the same distance as the target). When the user is in a building, for example, an arbitrary object which exists outside the window of the building may be a target in the background. As will be described later, the distance from the electronic apparatus 10 to the target can be calculated when the stereo camera is used. The distance to the target in the background should preferably exceed the measurement limit in the electronic apparatus 10.

As described above, when the display position of the calibration image on the left-eye display 12a is shifted from the reference position to the right side and the display position of the calibration image on the right-eye display 12b is shifted from the reference position to the left side, the convergence distance in the case of fixating on the AR image of the predetermined mark can be reduced. In contrast, when the display position of the calibration image on the left-eye display 12a is shifted from the reference position to the left side and the display position of the calibration image on the right-eye display 12b is shifted from the reference position to the right side, the convergence distance in the case of fixating on the AR image of the predetermined mark can be increased. To make such an accommodation to the convergence distance, the user performs an operation of the touch sensor 14. More specifically, for example, when the user performs an operation of passing his finger over the touch sensor 14 provided in the temple portion of the electronic apparatus 10 in the direction opposite to the user's sight-line, the display positions of the calibration images are shifted (adjusted) such that the convergence distance is reduced. In contrast, when the user performs an operation of passing his finger over the touch sensor 14 provided in the temple portion of the electronic apparatus 10 in the direction of the user's sight-line, the display positions of the calibration images are shifted (adjusted) such that the convergence distance is increased. Such operations performed by the user are accepted by the operation accepting module 104.

When an accommodation is made such that a convergence distance in the case of fixating on the target in the background corresponds to the convergence distance in the case of fixating on the AR image of the predetermined mark, the image acquisition module 101 acquires images of a scene in the direction of the user's sight-line captured by the camera 13.

The target specification module 102 specifies an object (target) that the user is fixating on from the images acquired by the image acquisition module 101 based on the user's sight-line (direction) detected by the sight-line detection sensor 15.

Sight-line detection executed by the sight-line detection sensor 15 and specification processing of the target executed by the target specification module 102 are hereinafter described in detail. When an infrared camera having a function of capturing an image of infrared light is used as the sight-line detection sensor 15, the sight-line detection sensor 15 captures an image while the user's face (eyes) is irradiated by infrared light from, for example, an infrared LED. In this case, for example, by using a position on the cornea of reflected light generated by the infrared light (i.e., corneal reflection) in the image captured by the sight-line detection sensor 15 as a reference point and using the pupil in the image as a moving point, the sight-line detection sensor 15 can detect the user's sight-line direction based on a position of the moving point with respect to the reference point. The target specification module 102 can specify a fixation position on the images acquired by the image acquisition module 101 based on the user's sight-line direction thus detected and the distance between the user's eyes and the sight-line detection sensor 15. The target specification module 102 specifies an object which exists in an area including the fixation position on the images acquired by the image acquisition module 101 as a target.

The infrared camera is used as the sight-line detection sensor 15 in the above example, but a visible light camera may also be used as the sight-line detection sensor 15. In this case, for example, by using an inner corner of the eye in an image captured by the sight-line detection sensor 15 as a reference point and using the iris as a moving point, the sight-line detection sensor 15 can detect the user's sight-line direction based on a position of the moving point with respect to the reference point. Therefore, the target specification module 102 can specify the target even if the visible light camera is used as the sight-line detection sensor 15.

The specification processing of the target is executed by using at least one of images captured by the left-eye camera 13a and the right-eye camera 13b.

Next, the distance calculator 103 calculates a distance from the electronic apparatus 10 to the target specified by the target specification module 102 based on, for example, an image (hereinafter referred to as a left-eye image) captured by the left-eye camera 13a and an image (hereinafter referred to as a right-eye image) captured by the right-eye camera 13b.

Since both the left-eye image and the right-eye image are images of the scene in the direction of the user's sight-line, the images are substantially the same. However, since the left-eye camera 13a and the right-eye camera 13b are provided at different positions, the left-eye image and the right-eye image duplicate binocular parallax whereby space can be three-dimensionally recognized. That is, the distance calculator 103 can calculate the distance to the target based on a difference (parallax) between the target in the left-eye image and the target in the right-eye image. When the distance to the target exceeds the measurement limit as described above, the distance to the target is the limit value.

By the above-described processing, a shift amount in a state of fixating on the target in the background (and the AR image at the same distance as the target) and the distance to the target are acquired (block B1).

After the processing in block B1 is executed, processing in block B2 and processing in block B3 are executed.

The processing in block B2 is the same as the processing in block B1 except that the target is an object seen in the middle ground from the user. When the user is in a building, for example, the window or the wall of the building may be a target in the middle ground. When the processing in block B2 is executed, a shift amount in a state of fixating on the target in the middle ground (and the AR image at the same distance as the target) and a distance to the target are acquired.

The processing in block B3 is the same as the processing in block B1 except that the target is an object seen in the foreground from the user. When the user is in a building, for example, a PC monitor on the desk used by the user may be a target in the foreground. When the processing in block B3 is executed, a shift amount in a state of fixating on the target in the foreground (and the AR image at the same distance as the target) and a distance to the target are acquired.

When the target (target in the background, middle ground or foreground) exists at a known distance, the known distance may be used without calculating a distance to the target.

When the processing in block B2 and the processing in block B3 are executed, the calibration module 105 generates calibration data by performing, for example, piecewise linear interpolation processing for the shift amounts and the distances acquired in blocks B1 to B3 (block B4). The calibration data is, for example, data indicative of a shift amount according to distance.

The calibration data generated by the calibration module 105 is stored in the storage 106. The calibration data is used when display images are displayed in the image display processing to be described below.

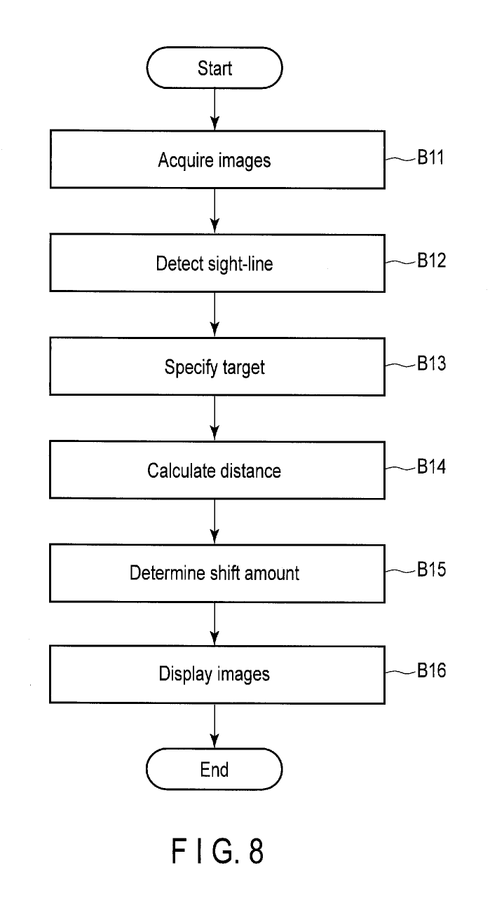

Next, a procedure of the image display processing is hereinafter described with reference to a flowchart of FIG. 8. The image display processing is executed, for example, when the user is wearing the electronic apparatus 10 and fixating on an arbitrary object which exists in reality through the display 12.

First, the image acquisition module 101 acquires images of a scene in the direction of the user's sight-line captured by the camera 13 (block B11). The images acquired by the image acquisition module 101 include images (a left-eye image and a right-eye image) captured by the left-eye camera 13a and the right-eye camera 13b, respectively.

The sight-line detection sensor 15 can detect the user's sight-line (direction) as described above (block B12).

An infrared camera, a visible light camera or the like can be used as the sight-line detection sensor 15, but a sensor other than the infrared camera and the visible light camera may be used as the sight-line detection sensor 15 as long as the sensor can detect the user's sight-line. More specifically, the sight-line detection sensor 15 may be configured to detect a sight-line direction by using, for example, electrooculography sensing technology. The electrooculography sensing technology is technology to measure a difference in potential between the cornea side and the retina side of the eyeball which varies according to the movement of the eye by electrodes attached to the periphery of the eye. The sight-line detection sensor 15 may also be a sensor configured to recognize positions of the left and right pupils by measuring an intensity difference of reflected light from the white of the eye and the iris and pupil of the eye by means of, for example, an optical sensor in an array shape, and then detect a sight-line from the positional relationship.

In addition, a sight-line detection sensor 15 may include several types of sight-line detection sensors 15 different in property. In this case, sensor to be used may be switched depending on the circumstance surrounding (the user wearing) the electronic apparatus 10. More specifically, the infrared camera may be used indoors and the optical sensor may be used in well-lighted outdoor space. The circumstance surrounding the electronic apparatus 10 can be determined by means of a sensor capable of detecting, for example, intensity of surrounding light. According to such a structure, the detection accuracy of the sight-line detection sensor 15 can be improved.

Next, the target specification module 102 specifies (determines) an object (target) that the user is fixating on from the images acquired by the image acquisition module 101 based on the user's sight-line (direction) detected by the sight-line detection sensor 15 (block B13). Since the specification processing of the target has been described above along with the calibration processing, the detailed description is omitted.

The distance calculator 103 calculates a distance to the target specified by the target specification module 102 based on a difference between the target in the left-eye image and the target in the right-eye image included in the images acquired by the image acquisition module 101 (block B14).

When the electronic apparatus 10 does not include a stereo camera, the distance to the target may be calculated by means of, for example, an active stereo sensor or a time-of-flight (TOF) sensor. The active stereo sensor is a 3D sensor that captures an image of a target by an infrared camera, for example, while the target is irradiated by a known pattern of infrared light, and calculates a distance (depth) at each point on the captured image based on the image. The TOF sensor is a sensor that captures an image by an infrared camera while scanning an infrared pulse and measures a distance to a target based on a reciprocation time of the infrared light. The distance can also be calculated based on color deviation obtained by a monocular camera and a semicircle color filter, by computational imaging.

Next, the shift amount determination module 107 determines a shift amount to be applied to the display images in accordance with the distance to the target calculated by the distance calculator 103 (block B15). More specifically, the shift amount determination module 107 determines a shift amount associated with the distance to the target in the calibration data stored in the storage 106 in the calibration processing as a shift amount to be applied to the display images.

The display controller 108 displays the display images on the left-eye display 12a and the right-eye display 12b, respectively (block B16). In this case, the display controller 108 displays the display images at positions shifted from the above-described reference positions based on the shift amount determined by the shift amount determination module 107. The convergence distance in the case of fixating on the AR image through the display 12 is thereby accommodated.

The convergence distance in the case of fixating on the AR image is accommodated based on the shift amount determined by the shift amount determination module 107 as described above. In a surface parallel to the surface including the two pupils of the user, the AR image is formed at a position where the user can recognize the AR image as an image related to the target.

The display image displayed on the left-eye display 12a and the display image displayed on the right-eye display 12b are related to the target and correspond to each other to form the AR image. It is assumed that the display images (images related to the target) displayed on the left-eye display 12a and the right-eye display 12b have been preliminarily prepared and associated with the target. The display images may be stored in the electronic apparatus 10 or acquired from an external apparatus. The display images may be selected by the user from a plurality of images acquired from an external apparatus.

According to the above-described image display processing, the convergence distance in the case of fixating on the AR image can be automatically adjusted depending on a distance to the target that the user is fixating on through the display 12.

When an actual distance to the target is different from the distance calculated in the processing in block B14, the convergence distance in the case of fixating on the target is also different from the convergence distance in the case of fixating on the AR image. In this case, switching the user's eyes between the target and the AR image places a significant burden on the eyes. The possibility of such a case must be reduced to a minimum depending on a use status of the electronic apparatus 10. Therefore, for example, a plurality of shift amounts to be applied to the display images displayed on the display 12 may be determined based on the calibration data such that the user can select a suitable shift amount (i.e., the convergence distance in the case of fixating on the AR image) from the shift amounts. In other words, a shift amount may be applied in several steps in accordance with a distance to the target.

After the display images are displayed in block B16 as described above, the convergence distance may be further manually adjusted by horizontally shifting the display positions of the display images on the display 12 in response to an operation of the touch sensor 14 performed by the user.

When the automated adjustment of the convergence distance in the above-described image display processing is not necessary, display images may be displayed to form an AR image at the reference convergence distance and then the user may manually adjust a convergence distance in the case of fixating on the AR image.

When the user switches his eyes from a target (hereinafter referred to as a first target) to another target (hereinafter referred to as a second target), the above-described image display processing is executed again and images related to the second target is displayed on the display 12. In this case, images related to the first target and the images related to the second target may be displayed on the display 12 such that an AR image formed by displaying the images related to the first target is seen at the same convergence distance as a convergence distance in the case of fixating on the first target and an AR image formed by displaying the images related to the second target is seen at the same convergence distance as a convergence distance in the case of fixating on the second target. The user can thereby see AR images related to a plurality of targets that the user has fixated on. When the user switches his eyes to the second target, only the images related to the second target may be displayed.

As described above, in the present embodiment, a display image (first image) related to a target (first target) which exists in the user's field of view is displayed on the left-eye display 12a (first display area) and a display image (second image) related to the target is displayed on the right-eye display 12b (second display area), whereby an AR image is formed behind the display 12. In the present embodiment, a distance (first distance) from the electronic apparatus 10 to an intersection point of the user's sight-line passing from the pupil of the left eye of the user through the display image 201 displayed on the left-eye display 12a and the user's sight-line passing from the pupil of the right-eye of the user through the display image 201 displayed on the right-eye display 12b is determined depending on a display position of the display image 201 on the left-eye display 12a and a display position of the display image 201 on the right-eye display 12b. The display position of the display image 201 on the left-eye display 12a and the display position of the display image 201 on the right-eye display 12b are determined in accordance with a distance (second distance) from the electronic apparatus 10 to the target. According to such a structure, an accommodation range of a convergence distance in the case where the user switches his eyes between the target which exists in reality and the AR image can be reduced in the present embodiment, which can lighten a burden imposed on the user's eyes by the accommodation of convergence.

Since the present embodiment includes the sight-line detection sensor 15, a target that the user is fixating on can be specified based on the user's sight-line direction detected by the sight-line detection sensor 15.

In the present embodiment, images related to a plurality of targets are displayed such that each AR image is formed at a convergence distance determined depending on a distance from the electronic apparatus 10 to a corresponding target. According to this, for example, images related to a plurality of targets that the user fixated on can be sequentially displayed, and an AR image formed by displaying images related to a target that the user last fixated on can be confirmed as a history.

In the present embodiment, the display position of the display image on the left-eye display 12a and the display position of the display image on the right-eye display 12b are adjusted in response to an operation of the touch sensor 14. According to such a structure, the user can manually adjust the convergence distance in the case of fixating on the AR image to a desired convergence distance.

In the present embodiment, the user can select a convergence distance in the case of fixating on the AR image from a plurality of convergence distances determined based on a distance from the electronic apparatus 10 to the target. Therefore, even if an actual distance to the target is different from the distance calculated by the distance calculator 103, the effect of the difference can be lessened.

When a stereo camera is used in the present embodiment, right and left distortion (perspective distortion) of a target can be obtained. A 3D AR image can be displayed by applying the distortion thus obtained to display images displayed on the left-eye display 12a and the right-eye display 12b (i.e., by distorting images seen by the left and right eyes, respectively). According to this, a difference in space recognition between the target and the AR image can be reduced. The display images displayed on the left-eye display 12a and the right-eye display 12b may be, for example, images different in parallax generated based on a single image and depth data (distance to the target) in the technology called an integral imaging method.

In the present embodiment, images (third and fourth images) other than those related to an object (target) which exists in the user's field of view may be further displayed on the left-eye display 12a and the right-eye display 12b. The images other than the images related to the object which exists in the user's field of view include, for example, images related to predetermined information specified by the user (for example, images indicative of weather, map, etc.). In this case, the user can see (the information on) the weather, map, etc., in addition to the information on the target. A difference between a convergence distance (third distance) in the case of fixating on an AR image formed by displaying the images related to the predetermined information and a distance from the electronic apparatus 10 to the target (i.e., the convergence distance in the case of fixating on the target) must be greater than or equal to a predetermined value (threshold value). That is, by allowing an AR image regarding the target and an AR image regarding the predetermined information to be seen at different convergence distances (for example, by allowing the AR image regarding the predetermined information to be seen in front of the AR image regarding the target), the user can easily understand (a type of) information obtained from each of the AR images.

In the present embodiment, a convergence distance is adjusted by using calibration data generated in the calibration processing executed as preprocessing of the image display processing. When a pupillary distance of the user who wears the electronic apparatus 10 has been preliminarily measured, however, display positions of display images can be determined without using the calibration data. More specifically, since a convergence angle in the case of fixating on a target can be calculated based on a distance to the target and the pupillary distance, display positions of display images on the left-eye display 12a and the right-eye display 12b can be determined such that an AR image is seen at the convergence angle.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method executed by an electronic apparatus worn by a user with a transparent first display area and a transparent second display area, the method comprising:
displaying, in the first display area, a first image associated with a first object which exists in a field of view of a user;
displaying, in the second display area, a second image associated with the first object; and
determining a first distance from the electronic apparatus to an intersection point based on a display position of the first image and a display position of the second image, the intersection point between a sight-line from the user's left eye through the first image and a sight-line from the user's right eye through the second image,
wherein the display positions of the first image and the second image are determined based on a second distance from the electronic apparatus to the first object.

2. The method of claim 1, further comprising,
detecting a sight-line direction of the user through the first display area or the second display area,
wherein the first object is determined based on the detected sight-line direction.

3. The method of claim 1, further comprising:
displaying, in the first display area, a third image associated with a second object which exists in the field of view of the user and is different from the first object;
displaying, in the second display area, a fourth image associated with the second object; and
determining a third distance from the electronic apparatus to an intersection point based on a display position of the third image and a display position the fourth image, the intersection point between a sight-line from the left eye through the third image and a sight-line from the right eye through the fourth image,
wherein the display positions of the third image and the fourth image are determined based on a fourth distance from the electronic apparatus to the second object.

4. The method of claim 1, further comprising:
displaying, in the first display area, a third image other than an image associated with an object which exists in the field of view of the user; and
displaying, in the second display area, a fourth image other than the image associated with the object,
wherein a difference between the second distance from the electronic apparatus to the first object and a third distance from the electronic apparatus to an intersection point is greater than or equal to a threshold value, the intersection point between a sight-line from the left eye through the third image and a sight-line from the right eye through the fourth image.

5. The method of claim 1, further comprising:
detecting a moving direction of a contact position of a finger of the user on a portion of the electronic apparatus;
adjusting the display position of the first image and the display position of the second image such that the first distance is increased when the detected moving direction is a first direction; and
adjusting the display position of the first image and the display position of the second image such that the first distance is reduced when the detected moving direction is a second direction.

6. The method of claim 1, wherein
the first distance is selected by the user from a plurality of distances determined based on the second distance.

7. An electronic apparatus worn by a user with a transparent first display area and a transparent second display area, the electronic apparatus comprising:
circuitry configured to:
display, in the first display area, a first image associated with a first object which exists in a field of view of a user, and display, in the second display area, a second image associated with the first object; and
determine a first distance from the electronic apparatus to an intersection point based on a display position of the first image and a display position of the second image, the intersection point between a sight-line from the user's left eye through the first image and a sight-line from the user's right eye through the second image,
wherein the display positions of the first image and the second image are determined based on a second distance from the electronic apparatus to the first object.

8. The electronic apparatus of claim 7, further comprising,
a detector configured to detect a sight-line direction of the user through the first display area or the second display area,
wherein the first object is determined based on the detected sight-line direction.

9. The electronic apparatus of claim 7, wherein
the circuitry is further configured to:
display, in the first display area, a third image associated with a second object which exists in the field of view of the user and is different from the first object, and display, in the second display area, a fourth image associated with the second object; and
determine a third distance from the electronic apparatus to an intersection point based on a display position of the third image and a display position the fourth image, the intersection point between a sight-line from the left eye through the third image and a sight-line of the right eye through the fourth image,
wherein the display positions of the third image and the fourth image are determined based on a fourth distance from the electronic apparatus to the second object.

10. The electronic apparatus of claim 7, wherein
the circuitry is further configured to
display, in the first display area, a third image other than an image associated with an object which exists in the field of view of the user, and display, in the second display area, a fourth image other than the image associated with the object,
wherein a difference between the second distance from the electronic apparatus to the first object and a third distance from the electronic apparatus to an intersection point is greater than or equal to a threshold value, the intersection point between a sight-line from the left eye through the third image and a sight-line from the right eye through the fourth image.

11. The electronic apparatus of claim 7, further comprising:
a detector configured to detect a moving direction of a contact position of a finger of the user on a portion of the electronic apparatus,
wherein the circuitry is configured to adjust the display position of the first image and the display position of the second image such that the first distance is increased when the detected moving direction is a first direction, and adjust the display position of the first image and the display position of the second image such that the first distance is reduced when the detected moving direction is a second direction.

12. The electronic apparatus of claim 7, wherein
the first distance is selected by the user from a plurality of distances determined based on the second distance.

13. A non-transitory computer-readable storage medium having stored thereon a computer program which is executable by a computer of an electronic apparatus worn by a user with a transparent first display area and a transparent second display area, the computer program comprising instructions capable of causing the computer to execute functions of:
displaying, in the first display area, a first image associated with a first object which exists in a field of view of the user; and
displaying, in the second display area, a second image associated with the first object,
a first distance from the electronic apparatus to an intersection point based on a display position of the first image and a display position of the second image, the intersection point between a sight-line from the left eye through the first image and a sight-line from the right eye through the second image,
wherein the display positions of the first image and the second image are determined based on a second distance from the electronic apparatus to the first object.

14. The storage medium of claim 13, wherein
the computer program comprises instructions capable of causing the computer to further execute a function of detecting a sight-line direction of the user through the first display area or the second display area, and
the first object is determined based on the detected sight-line direction.

15. The storage medium of claim 13, wherein
the computer program comprises instructions capable of causing the computer to further execute functions of:
displaying, in the first display area, a third image associated with a second object which exists in the field of view of the user and is different from the first object; and
displaying, in the second display area, a fourth image associated with the second object,
determining a third distance from the electronic apparatus to an intersection point based on a display position of the third image and a display position the fourth image, the intersection point between a sight-line from the left eye through the third image and a sight-line from the right eye through the fourth image,
wherein the display positions of the third image and the fourth image are determined based on a fourth distance from the electronic apparatus to the second object.

16. The storage medium of claim 13, wherein
the computer program comprises instructions capable of causing the computer to further execute functions of:
displaying, in the first display area, a third image other than an image associated with an object which exists in the field of view of the user; and
displaying, in the second display area, a fourth image other than the image associated with the object,
wherein a difference between the second distance from the electronic apparatus to the first object and a third distance from the electronic apparatus to an intersection point is greater than or equal to a threshold value, the intersection point between a sight-line of the left eye through the third image and a sight-line of the right eye through the fourth image.

17. The storage medium of claim 13, wherein
the computer program comprises instructions capable of causing the computer to further execute functions of:
detecting a moving direction of a contact position of a finger of the user on a portion of the electronic apparatus;
adjusting the display position of the first image and the display position of the second image such that the first distance is increased when the detected moving direction is a first direction; and
adjusting the display position of the first image and the display position of the second image such that the first distance is reduced when the detected moving direction is a second direction.

18. The storage medium of claim 13, wherein
the first distance is selected by the user from a plurality of distances determined based on the second distance.
